(19) United States
(12) Patent Application Publication
(10) Pub. No.: US 2026/0207420 A1
(43) Pub. Date: Jul. 23, 2026

(54) SEX TOY

(71) Applicant: Dongguan Mimao Electronic Technology Co., Ltd., Dongguan (CN)

(72) Inventor: Qinling WANG, Heyuan (CN)

(21) Appl. No.: 19/444,236

(22) Filed: Jan. 9, 2026

Related U.S. Application Data
(63) Continuation of application No. PCT/IB2025/051704, filed on Feb. 18, 2025.

(30) Foreign Application Priority Data
Jan. 9, 2025 (CN) 202510040947.3
Jan. 9, 2025 (WO) PCT/CN2025/071486
Jul. 11, 2025 (DE) 202025103998.2

(51) Int. Cl. A61H 19/00; A61H 7/00; A61H 23/02

(52) U.S. Cl. CPC A61H 19/32; A61H 7/00; A61H 23/0254; A61H 2201/0107; A61H 2201/1215; A61H 2201/14; A61H 2201/1669; A61H 2201/1671; A61H 2201/1673; A61H 2201/1676; A61H 2201/1692; A61H 2201/1695; A61H 2205/087

(57) ABSTRACT

A sex toy includes a shell, a first massage portion, a second massage portion and a driving unit. The first massage portion is connected to the shell and defines a receiving cavity for receiving a male penis. The second massage portion is connected to the shell and located at an axial end of the receiving cavity. The driving unit is received in the shell and in transmission connection with the second massage portion to drive the second massage portion to rotate and/or swing relative to the first massage portion, an axis of rotation and/or swing of the second massage portion is misaligned with a central axis of the receiving cavity of the first massage portion.

### CROSS-REFERENCE TO RELATED APPLICATIONS

The present application is a Continuation Application of PCT Application No. PCT/IB 2025/051704, filed on Feb. 18, 2025, which claims the priority of Chinese Patent Application No. 202510040947.3, filed on Jan. 9, 2025. The present application claims priority of PCT Application No. PCT/CN 2025/071486, filed on Jan. 9, 2025. The present application also claims priority of German Utility Model Application No. 202025103998.2, filed on Jul. 11, 2025, which was published as Publication DE202025103998U1. The entire contents of all the above-mentioned applications are hereby incorporated by reference.

### TECHNICAL FIELD

The present disclosure relates to the technical field of sexual stimulation, and in particular to a sex toy.

### BACKGROUND

With the improvement of living standards and the increase of pressure on people's life and work, sex toys, such as masturbators, are welcomed by more and more people. Most of the typical masturbators are equipped with vibration motors in their casings to stimulate the users'genitalia by means of high-frequency vibration for sexual pleasure. However, such sex toys usually provide monotonous stimulation effects, resulting in insufficient stimulation effects that are therefore unable to satisfy the users.

### SUMMARY

An object of the present disclosure is to provide a sex toy with a better stimulation effect to improve the users'sexual experience.

In order to achieve the above object, a technical solution of the present disclosure provides a sex toy, the sex toy including:
a shell;
a first massage portion, connected to the shell and defining a receiving cavity for receiving a male penis;
a second massage portion, connected to the shell and located at an axial end of the receiving cavity;
a driving unit, received in the shell and in transmission connection with the second massage portion to drive the second massage portion to rotate and/or swing relative to the first massage portion,
wherein an axis of rotation and/or swing of the second massage portion is misaligned with a central axis of the receiving cavity of the first massage portion.

Another technical solution of the present disclosure provides a sex toy, the sex toy including:
a shell;
a first massage portion, connected to the shell, the shell and the first massage portion cooperatively defining a receiving cavity for accommodating a penis, the first massage portion providing a first stimulation to the penis;
a second massage portion, connected to the shell and located at an axial end of the receiving cavity;
a driving unit, in transmission connection with the second massage portion to drive the second massage portion to rotate and/or swing relative to the first massage portion and providing a second stimulation to the penis different from the first stimulation.

Compared with the prior art, the sex toy provided by the embodiments of the present disclosure has a plurality of massage portions, wherein the second massage portion is arranged at an axial end of the receiving cavity, and is able to rotate, swing, or perform other motions to provide, together with the first massage portion, multi-angle and multi-direction stimulation.

### BRIEF DESCRIPTION OF THE DRAWINGS

In order to illustrate the technical solution in embodiments of the present disclosure more clearly, the following briefly introduces accompanying drawings used in the description of the embodiments. Apparently, the accompanying drawings in the following description are only some embodiments of the present disclosure. Those of ordinary skill in the art can obtain other accompanying drawings from these accompanying drawings without any creative efforts.

FIG. 1 is a structural schematic view illustrating the structure of a sex toy according to an embodiment of the present disclosure.

FIG. 2 is a schematic view illustrating the structure of the sex toy depicted in FIG. 1 from one view angle.

FIG. 3 is a sectional view illustrating the structure of the sex toy depicted in FIG. 2, taken along line A-A.

FIG. 4 is a sectional view illustrating the structure of the sex toy depicted in FIG. 3, taken along line B-B.

FIG. 5 is an exploded view of the sex toy depicted in FIG. 1.

FIG. 6 is a further exploded view of the sex toy depicted in FIG. 5, wherein the main structures, such as a driving unit and a vibration motor, are shown schematically.

FIG. 7 is a schematic view illustrating the structure of the sex toy according to another embodiment of the present disclosure.

FIG. 8 is a schematic view illustrating the structure of the sex toy according to yet another embodiment of the present disclosure.

FIG. 9 is a schematic view illustrating the structure of the sex toy depicted in FIG. 8 from another view angle.

FIG. 10 is a sectional view illustrating the structure of the sex toy depicted in FIG. 9, taken along line C-C.

FIG. 11 is an exploded view of the sex toy depicted in FIG. 8.

FIG. 12 is a schematic view illustrating the structure of the sex toy according to further another embodiment of the present disclosure.

FIG. 13 is a schematic view illustrating the structure of the sex toy depicted in FIG. 12 from another view angle.

FIG. 14 is a sectional view illustrating the structure of the sex toy depicted in FIG. 13, taken along line D-D.

FIG. 15 is an exploded view of the sex toy depicted in FIG. 12.

### LIST OF REFERENCE SIGNS:

Sex toy 100; shell 10; inner casing 11; outer casing 12; first massage portion 20; first contact body 21; second contact body 22; receiving cavity 23; central axis 231; annular body 24; protrusion 25; hole 26; second massage portion 30; connecting body 31; sleeve body 32; massage cavity 321; ellipsoid body 33; pivot axis 34; inner space 35; driving unit 40; first swing rod 41; first elongate slot 411; second swing rod 42; second elongate slot 421; actuator 43; output shaft 431; driving motor 432; gearbox 433; first transmission assembly 44; eccentric wheel 441; slider 442; first shaft rod 443; sliding groove 444; first sliding rod 445; second sliding rod 446; guide rail 447; first segment 448; second segment 449; first pivot rod 450; second pivot rod 451; second transmission assembly 46; second shaft rod 461; shaft sleeve 462; elastic body 50; vibration motor 51; battery 53; circuit board 54; massage space 55; granular bumps 56.

### DESCRIPTION OF THE EMBODIMENTS

In order to better understanding of the present disclosure, the following describes the disclosure more comprehensively with reference to the accompanying drawings. The drawings exemplarily illustrate one or more embodiments of the present disclosure to make comprehension of the technical solutions disclosed herein more accurate and thorough. It should be understood, however, that the present disclosure may be implemented in various forms and is not limited to the embodiments described below.

In the drawings of the present disclosure, identical or similar reference numerals correspond to identical or similar components. In the description of the present disclosure, it should be understood that directional terms such as “upper”, “lower”, “left”, and “right” are based on orientations or positional relationships shown in the drawings. These terms are used solely to simplify the description of the disclosure and do not imply or require that the referenced devices or components must have specific orientations or be constructed/operated in specific orientations. Therefore, directional terms in the drawings are provided for illustrative purposes only and should not be understood as a limitation of the present disclosure. Those skilled in the art may interpret these terms according to specific circumstances.

Furthermore, descriptions of “first”, “second”, or similar terms in the embodiments of the present disclosure are used solely for distinguishing purposes and should not be interpreted as indicating relative importance or implicitly specifying the quantity of technical features. Features modified by “first” or “second” may explicitly or implicitly include at least one such feature. Additionally, the term “and/or” or “as well as/or” in the present disclosure comprises three alternative scenarios. For example, “A and/or B” includes: (i) A alone, (ii) B alone, or (iii) both A and B.

In addition, technical solutions across different embodiments may be combined, but such combination must be based on what those skilled in the art can implement. If a combination of technical solutions results in contradictions or impractical implementation, it should be considered that such combination do not exist and are not within the scope of protection requested in this disclosure.

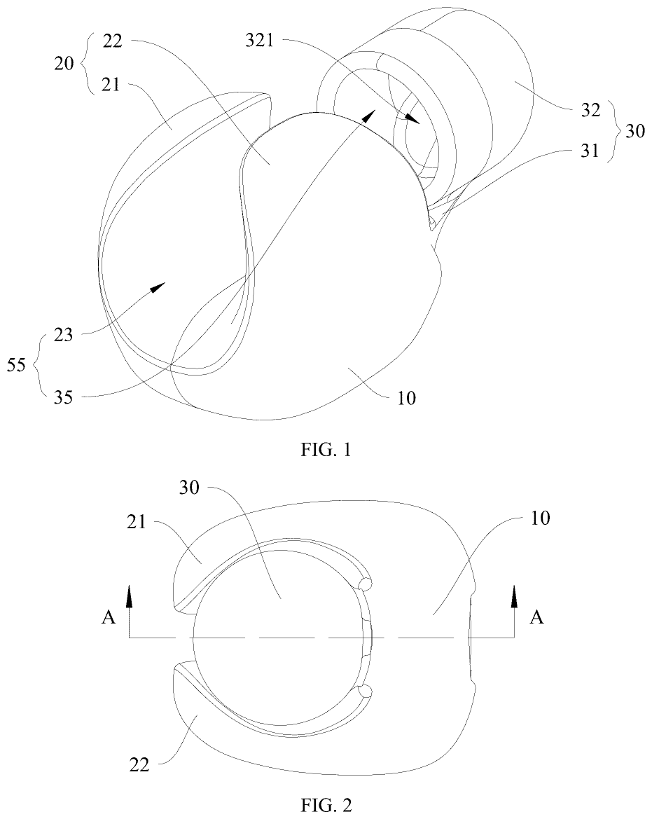

Referring to FIGS. 1 to 5, a sex toy 100 according to an embodiment of the present disclosure is shown. The sex toy 100 includes a shell 10, a first massage portion 20, a second massage portion 30 and a driving unit 40.

The first massage portion 20 is connected to the shell 10 and includes a first contact body 21 and a second contact body 22 disposed on opposite sides of the shell 10, the first and second contact bodies 21, 22 cooperatively enclose or define a receiving cavity 23 for accommodating a body part to be massaged, such as a male's penis. The receiving cavity 23 is designed to be adapted to fit the penis, and can provide massage to the penis in a wrapping manner, with better stability and comfort during massage. Specifically, the first and second contact bodies 21, 22, are arranged on opposite sides of the shell 10 along the lateral direction. A portion of the shell 10 that is located between the first and second contact bodies 21, 22, cooperates with the first contact body 21 and the second contact body 22 to form the receiving cavity 23. The first massage portion 20 provides a first stimulation to the penis through at least one of the following movements: vibration, swing, rotation and reciprocating sliding. Alternatively, the first massage portion 20 and the shell 10 cooperatively define a receiving cavity 23 for accommodating a penis.

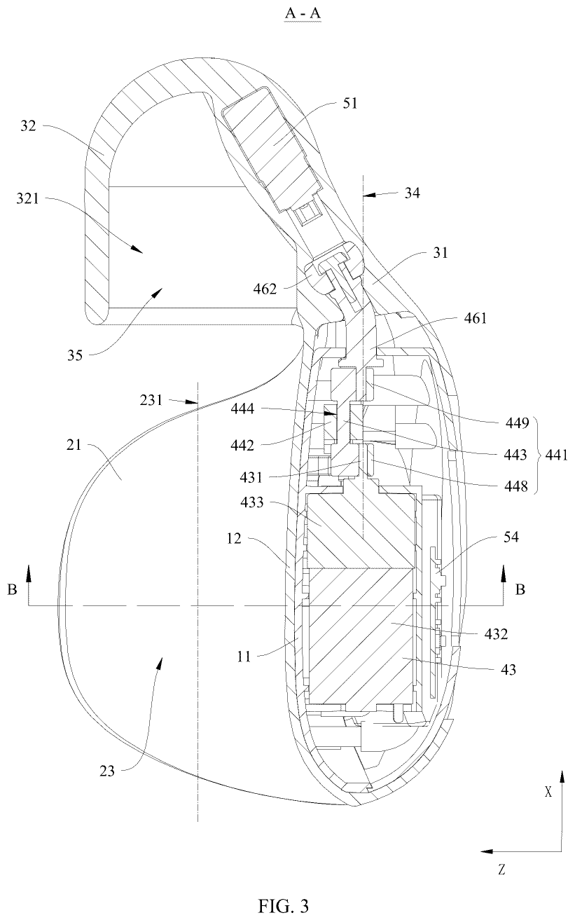

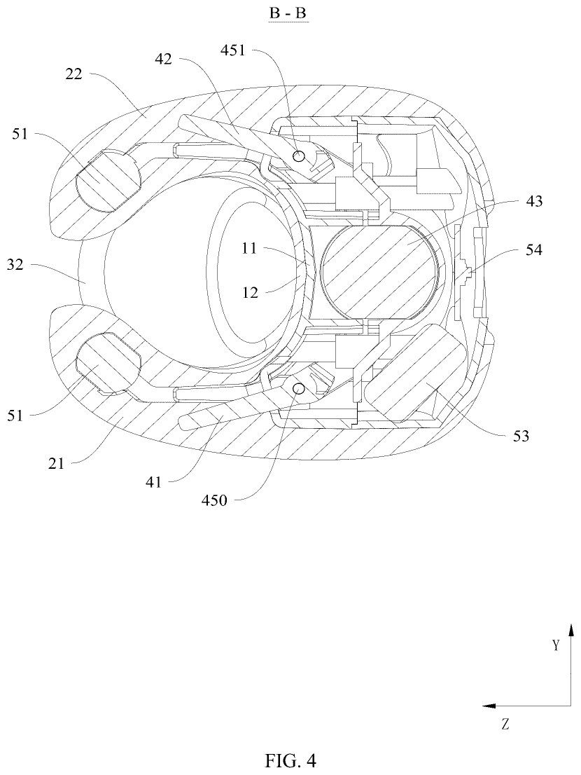

The second massage portion 30 is connected to the shell 10 and located at an axial end of the receiving cavity 23, so that the head of the user's penis can extend out of the receiving cavity 23 and interact with the second massage portion 30 after the user's penis inserts into the receiving cavity 23 of the first massage portion 20. For a better understanding, please refer to the coordinate in FIGS. 3 and 4, wherein the axial direction described herein is indicated by the X-direction, and the lateral direction is indicated by the Y-direction.

The second massage portion 30 provides a second stimulation to the penis, and preferably, the second stimulation is different from the first stimulation. In this embodiment, the second massage portion 30 is configured to rub a penile glans of the penis.

In particular, the driving unit 40 is received in the shell 10 and in transmission connection with the second massage portion 30 to drive the second massage portion 30 to rotate and/or swing relative to the first massage portion 20. That is, the driving unit 40 is capable of driving the second massage portion 30 to rotate or swing, or to rotate and swing simultaneously, so as to achieve the function of swing and/or rocking. In the context, rotation refers to a movement that the second massage portion 30 rotates in a specific direction continuously for at least one cycle (i.e. at least 360 degrees), while swing refers to a movement that the second massage portion 30 swings reciprocally within a rotation angle of less than one cycle. An axis of rotation and/or swing of the second massage portion 30 is misaligned or deviates from a central axis 231 of the receiving cavity 23 of the first massage portion 20. That is, the axis of rotation and/or swing of the second massage portion 30 and the central axis 231 of the receiving cavity 23 are not collinear or do not coincide, thereby allowing the second massage portion 30 not only to rub the periphery of the penis by moving in a circumferential direction relative to the penis, but also to cause the head of the penis to swing vertically and/or laterally, thus providing a better massage effect. To facilitate illustration, the axis of rotation and/or swing of the second massage portion 30 is hereinafter referred to as a pivot axis 34 of the second massage portion 30.

The sex toy 100 provided by the embodiments of the present disclosure has a plurality of massage portions 20, 30, wherein the second massage portion 30 is arranged at an axial end of the receiving cavity 23, and is able to rotate, swing, or perform other motions to provide, together with the first massage portion 20, multi-angle and multi-direction stimulation. Moreover, the first and second contact bodies 21, 22 cooperatively define the receiving cavity 23, which can be adapted to fit the penis of the male, and can provide wrap-around massage to the penis, with better stability and comfort during massage.

In one embodiment of the present disclosure, the shell 10 includes an inner casing 11 and an outer casing 12 wrapped around the outer periphery of the inner casing 11, and driving unit 40 is received in the inner shell 11. In one embodiment, the inner casing 11 is made of a rigid material, including but not limited to hard plastics such as polypropylene (PP), polyvinyl chloride (PVC), polycarbonate (PC), etc. Thus, it provides structural support with sufficient strength for the components received therein. The outer casing 12 is made of a soft material, including but not limited to a stretchable and soft silicone, which is non-toxic, antibacterial, and has good chemical stability. Therefore, the skin-friendly soft material can improve users'experience.

In one embodiment of the present disclosure, the first massage portion 20 is made of a soft material, including but not limited to a stretchable and soft silicone, which is non-toxic, antibacterial, and has good chemical stability. The first massage portion 20 which is made of a skin-friendly soft material can improve users'experience.

In one embodiment of the present disclosure, the second massage portion 30 is made of a soft material, including but not limited to a stretchable and soft silicone, which is non-toxic, antibacterial, and has good chemical stability. Similarly, the second massage portion 30, made of the skin-friendly soft material, can also improve users'experience.

In one embodiment of the present disclosure, each of the first and second massage portions 20, 30 is formed as a one-piece component by for example, but is not limited to, using mold pressing or injection. Thereby, it is ensured that there are no seams on the surfaces of the first massage portion 20 and the second massage portion 30, and the overall product is more aesthetic and well-sealed.

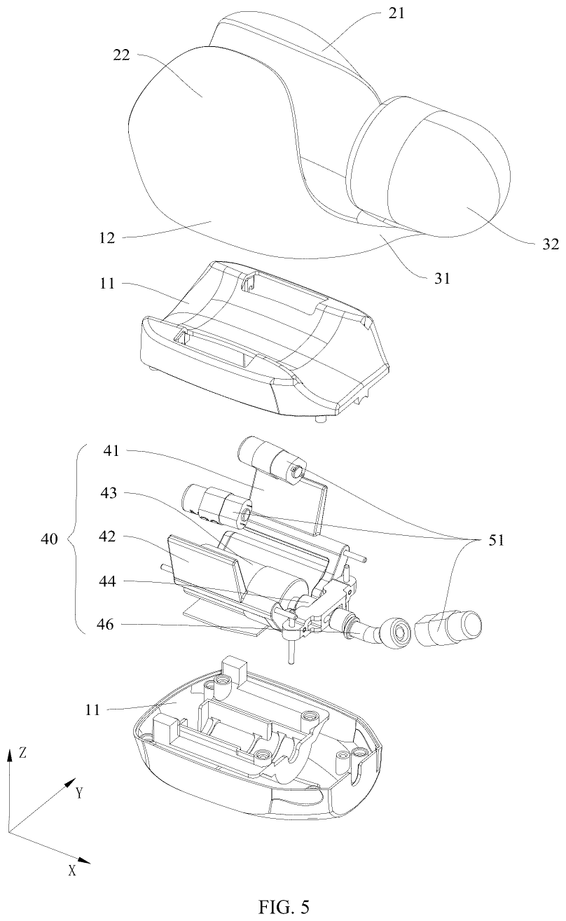

In one embodiment of the present disclosure, referring to FIG. 5, the first massage portion 20, the second massage portion 30 and the outer casing 12 are integrally molded as one single piece, thereby further improving the homogeneity and sealing of the overall product.

In one embodiment of the present disclosure, referring to FIG. 3, the axis of rotation and/or swing of the second massage portion 30 is parallel to the central axis 231 of the receiving cavity 23 of the first massage portion 20. For example, the central axis 231 of the receiving cavity 23 and the pivot axis 34 of the second massage portion 30 both extend in axial directions and are spaced apart in a vertical direction, wherein the vertical direction is indicated by the Z-direction as shown in FIG. 3.

In one embodiment of the present disclosure, the axis of rotation and/or swing of the second massage portion 30 is perpendicular to the central axis 231 of the receiving cavity 23 of the first massage portion 20. For example, in the case where the central axis 231 of the receiving cavity 23 extends in the axial direction, the pivot axis 34 of the second massage portion 30 may extend in the lateral direction (i.e. the Y-direction), in the vertical direction (i.e. the Z-direction), or other direction in a plane defined by the lateral and vertical directions (i.e. the YZ-plane).

In one embodiment of the present disclosure, referring to FIGS. 1 to 3, the second massage portion 30 is substantially cylindrical having an inner space 35, and the inner space 35 of the second massage portion 30 is communicated with the receiving cavity 23 of the first massage portion 20 to form a massage space 55 together. In this embodiment, the second massage portion 30 includes a connecting body 31 and a sleeve body 32 connected to an axial end of the connecting body 31. The inner space 35 of the sleeve body 32, serving as the inner space 35 of the second massage portion 30, is communicated with the receiving cavity 23 to cooperatively define the massage space 55. The pivot axis 34 is parallel to the central axis 231 of the receiving cavity 23. The connecting body 31 is substantially rod-like structure. One end of the connecting body 31 is connected to the shell 10, the other end of the connecting body 31 extends along in a direction inclined to the pivot axis 34, so as to enable the connecting body 31 and the sleeve body 32 to jointly rotate and/or swing inclinedly about the pivot axis 34 in the massaging state. The angle at which the connecting body 31 extends inclinedly relative to the pivot axis 34 is not particularly limited. For example, the angle may be in a range from greater than 0° to less than or equal to 90°, in particular, the angle may be a value of 15°, 30°, 45°, 60°, 70°, or 90°.

In one embodiment of the present disclosure, one end of the second massage portion 30 facing towards the first massage portion 20 is open, and the other end of the second massage portion 30 opposite to the one end is closed. Alternatively, both ends of the second massage portion 30 are open. That is, the inner space 35 of the sleeve body 32 is open at the end facing towards the receiving cavity 23 and is closed at the opposite end, or both ends of the inner space 35 are open. In this embodiment, referring to FIG. 3, the sleeve body 32 is provided with a massage cavity 321, one end of which facing towards the receiving cavity 23 is open. The massage cavity 321 is communicated with the receiving cavity 23 to jointly form a massage space 55.

In one embodiment of the present disclosure, the inner space 35 of the second massage portion 30 is substantially coaxial with the receiving cavity 34 of the first massage portion 20. That is, an axial axis of the inner space 35 of the second massage portion 30 and the central axis 231 of the receiving cavity 23 may be coaxial. Alternatively, the axial axis of the inner space 35 of the second massage portion 30 and the central axis 231 of the receiving cavity 23 may be approximately coaxial, for example, the two axes may be parallel, intersecting or even not on the same plane (skew lines) with a minor inconsistence. In the case that the two axes are parallel or skew lines, the shortest distance between the two axes is very small, e.g., less than or equal to 5 mm, and in the case that the two axes intersect, an angle between the two axes is very small, e.g., may be less than or equal to 5°.

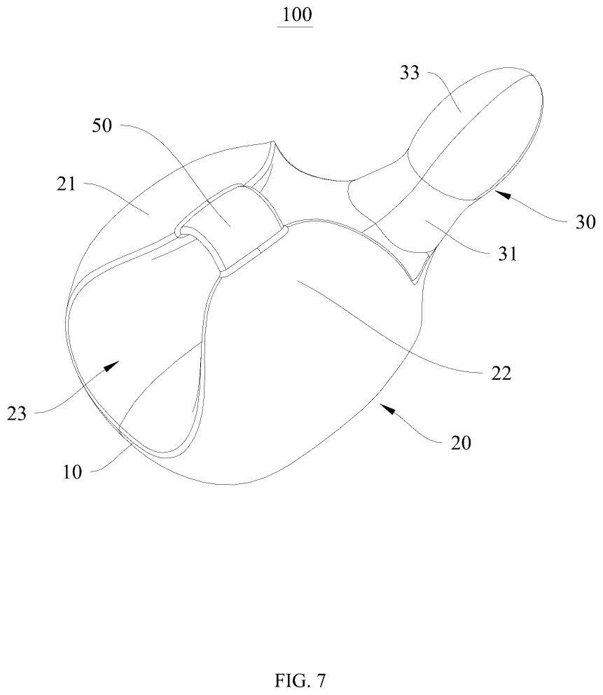

In one embodiment of the present disclosure, referring to FIG. 7, the second massage portion 30 is a plate-like structure or block-like structure. The second massage portion 30 extends inclinedly from an end of the shell 10 relative to its own axis of rotation and/or swing. In this embodiment, the second massage portion 30 includes a connection body 31 and an ellipsoid body 33. Two axial ends of the connection body 31 are connected to the shell 10 and the ellipsoid body 33, respectively. The connection body 31 is a substantially rod-like structure, and one end of the connecting body 31 is connected to the shell 10, the other end extends along in a direction inclined with respect to the pivot axis 34, so as to enable the connecting body 31 and the ellipsoid body 33 to jointly rotate and/or swing inclinedly about the pivot axis 34 in the massaging state. An angle at which the connecting body 31 extends inclinedly relative to the pivot axis 34 may be the same as those described in the above embodiments, and will not be described in detail here.

In one embodiment of the present disclosure, referring to FIGS. 1 to 4, the first and second contact bodies 21, 22 are curved plate-like structures. A distal end of the first contact body 21 and a distal end of the second contact body 22 are spaced apart in a circumferential direction of the receiving cavity 23, so that there is no interference when they move relative to each other. The curved surface structure can better fit the penis, effectively distribute the pressure, and avoid discomfort caused by single-point force.

In one embodiment of the present disclosure, referring to FIG. 7, an elastic body 50 is connected between the distal ends of the first and second contact bodies 21, 22. The elastic body 50 provides a flexible connection that can be stretched, compressed, bent or twisted within a certain range, which allows movements of the first and second contact bodies 21, 22 relative to each other, increasing wrapping effect of the product, as well as compatibility to different sizes of the penises of different users. The elastic body 50 is made of a soft material, including but not limited to a stretchable and soft silicone, which is non-toxic, antibacterial, and has good chemical stability.

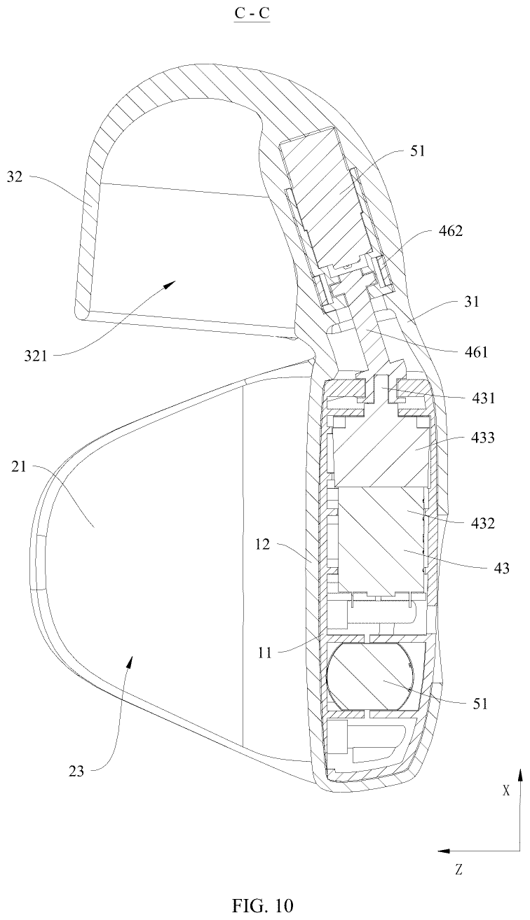

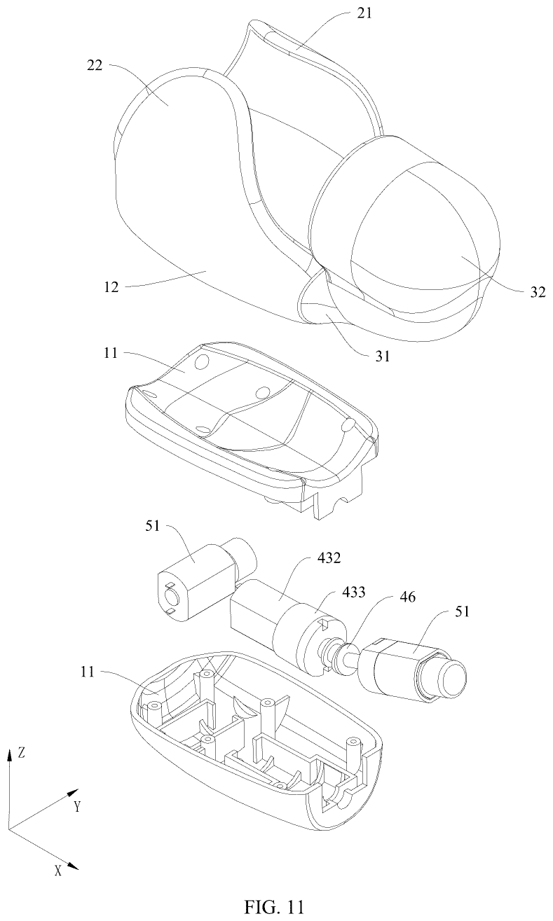

In one embodiment of the present disclosure, the sex toy 100 further includes at least one vibration motor 51. The at least one vibration motor 51 can provide a high-frequency vibration for massage. The position of the at least one vibration motor 51 is not particularly limited. For example, in one embodiment of the present disclosure, referring to FIGS. 4 to 6, a vibration motor 51 is embedded in the first massage portion 20. In another embodiment of the present disclosure, referring to FIGS. 3, 5, and 6, a vibration motor 51 is embedded in the second massage portion 30. In further another embodiment of the present disclosure, referring to FIGS. 10 and 11, a vibration motor 51 is embedded in the shell 10. It should be understood that, the at least one vibration motor 51 may include a plurality of vibration motors 51, which are provided in different positions, achieving multi-angle and multi-direction massage, and improving the users'experience.

In one embodiment of the present disclosure, referring to FIGS. 3 to 5, the driving unit 40 is also in transmission connection with the first massage portion 20 to drive the first and second contact bodies 21, 22 to move toward or away from each other, thereby changing the radial dimension of the receiving cavity 23 at a portion corresponding to the first and second contact bodies 21, 22. That is, the driving unit 40 is able to drive the first massage portion 20 to achieve a pinching movement for the penis received therein. By continuously changing the dimension of the receiving cavity 23, a continuous pinching massage is generated, which can simulate the natural feel of a real person's massage, promote the blood circulation of the penis, and make the user more comfortable.

The first and second contact bodies 21, 22 may move toward or away from each other by sliding or swinging. For example, in one embodiment of the present disclosure, referring to FIGS. 3 to 6, the driving unit 40 includes a first swing rod 41 and a second swing rod 42 disposed opposite to each other. The first and second swing rods 41, 42 are rotatably disposed in the shell 10 to drive the first and second contact bodies 21, 22 to swing towards or away from each other. That is, the swinging movements of the first and second contact bodies 21, 22 are achieved by rotations of the first and second swing rods 41, 42 relative to the shell 10.

In one embodiment of the present disclosure, referring to FIGS. 3 to 6, the driving unit 40 includes a actuator 43 having a driving motor 432, a first transmission assembly 44 and a second transmission assembly 46. The first transmission assembly 44 is connected between the actuator 43 and the first massage portion 20. The second transmission assembly 46 is connected between the actuator 43 and the second massage portion 30. Specifically, the actuator 43 is received in the shell 10, and the first transmission assembly 44 is configured to convert rotation of the actuator 43 into reciprocal swings of the first and second contact body 21, 22 in the lateral direction. The second transmission assembly 46 is configured to convert rotation of the actuator 43 into rotation and/or swing of the second massage portion 30.

In one embodiment of the present disclosure, referring to FIGS. 3, 5, and 6, the first transmission assembly 44 comprises an eccentric wheel 441 and a slider 442, the eccentric wheel 441 rotates about a driving axis under the drive of the actuator 43. The eccentric wheel 441 has a first shaft rod 443 extending outwardly, and the first shaft rod 443 is eccentrically arranged relative to the driving axis. The slider 442 has a sliding groove 444, and the first shaft rod 443 is movably engaged with the sliding groove 444. One end of the first swing rod 41 and one end of the second swing rod 42 are movably engaged with the slider 442, the other end of the first swing rod 41 and the other end of the second swing rod 42 extend into the first and second contact bodies 21, 22, respectively. That is, the eccentric wheel 441 includes the first shaft rod 443, both a connecting end of the first swing rod 41 and a connecting end of the second swing rod 42 are connected to the slider 442 and move together with the slider 442, a swinging end of the first swing rod 41 and a swinging end of the second swing rod 42 are received inside the first and second contact bodies 21, 22, respectively. The driving axis is the rotational axis of the output shaft 431 of the actuator 43. The actuator 43 drives the eccentric wheel 441 to rotate about the driving axis, and the first shaft rod 443 located on the eccentric wheel 441 revolves around the driving axis. The first shaft rod 443 drives the slider 442 to slide, and the slider 442 in turn drives the first and second swing rods 41, 42 to swing toward or away from each other, so that the first and second contact bodies 21, 22 will correspondingly swing toward or away from each other.

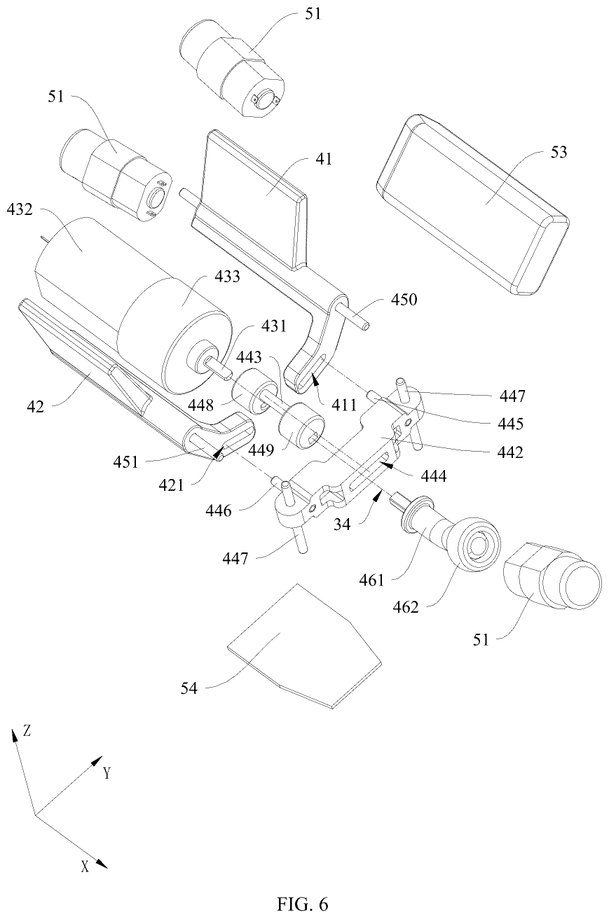

In one embodiment of the present disclosure, referring to FIGS. 3 and 6, the eccentric wheel 441 is in torque transmission connection with the actuator 43. The eccentric wheel 441 extends along the axial direction and rotates about the driving axis of the actuator 43. The axial axis of the eccentric wheel 441 is arranged eccentrically relative to the driving axis. The first shaft rod 443 extends along the axial direction and is slidably inserted into the sliding groove 444 which extends in the lateral direction. The first transmission assembly 44 further includes a pair of guide rails 447 extending vertically, parallel and spaced apart from each other. The slider 442 is slidably disposed on the pair of guide rails 447. The pair of guide rails 447 are both fixed to the shell 10 for guiding the sliding direction of the slider 442. When the actuator 43 drives the eccentric wheel 441 to rotate, the first shaft rod 443 revolves relative to the driving axis, and the first shaft rod 443 will slide in the sliding groove 444 and drive the slider 442 to do linear reciprocation motion on the pair of guide rails 447 in the vertical direction.

In one embodiment of the present disclosure, referring to FIG. 6, the slider 442 is provided with a first sliding rod 445 and a second sliding rod 446 extending axially, respectively. A connecting end of the first swing rod 41 has a first elongate slot 411, a connecting end of the second swing rod 42 has a second elongate slot 421. The first sliding rod 445 is slidably engaged in the first elongate slot 411, and the second sliding rod 446 is slidably engaged in the second elongate slot 421. That is, the first and second sliding rods 445, 446 will slide within the first and second elongate slots 411, 421, during sliding of the slider 442 in the vertical direction.

In one embodiment of the present disclosure, referring to FIGS. 4 and 6, the first transmission assembly 44 includes a first pivot rod 450 and a second pivot rod 451 both extending in parallel along the axial direction and spaced apart from each other. Optionally, the first and second swing rods 41, 42 are rotatably engaged with the first and second pivot rods 450, 451, respectively. Both the first and second pivot rods 450, 451 are fixed to the shell 10. Alternatively, the first and second swing rods 41, 42 are fixed to the first and second pivot rods 450, 451, respectively, and both the first and second pivot rods 450, 451 are rotatably engaged with the shell 10. Alternatively, the first and second swing rods 41, 42 are rotatably engaged with the first and second pivot rods 450, 451, respectively, and both the first and second pivot rods 450, 451 are also rotatably engaged with the shell 10. The first pivot rod 450 is rotatably connected to the first swing rod 41 at a portion between the connecting end and swinging end thereof, that is, the first pivot rod 450 is substantially connected to the middle of the first swing rod 41. The second pivot rod 451 is rotatably connected to the second swing rod 42 at a portion between the connecting end and the swinging end thereof, that is, the second pivot rod 451 is substantially connected to the middle of the second swing rod 42. The slider 442 drives the first and second sliding rods 445, 446 to move in the vertical direction and slide in the first and second elongate slots 411, 421, respectively, which in turn causes the connecting end of the first swing rod 41 and the connecting end of the second swing rod 42 to swing around the first and second pivot rod 450, 451, respectively, so that the swinging end of the first swing rod 41 and the swinging end of the second swing rod 42 correspondingly swing around the first and second pivot rod 450, 451, and the first and second contact bodies 21, 22 therefore swing laterally toward or away from each other.

In one embodiment of the present disclosure, referring to FIGS. 3 and 6, the second transmission assembly 46 includes a second shaft rod 461. One end of the second shaft rod 461 is connected to the eccentric wheel 441, the other end of the second shaft rod 461 extends inclinedly into the second massage portion 30 relative to the axis of rotation and/or swing of the second massage portion 30. Specifically, the eccentric wheel 441 includes a first segment 448, a second segment 449, and the first shaft rod 443 connected between the first and second segments 448, 449, an axial axis of the first segment 448 coincides with an axial axis of the second segment 449. An axial axis of the first shaft rod 443 is arranged eccentrically relative to the axial axes of the first and second segments 448, 449. One end of the second shaft rod 461 is connected to the second segment 449. The second transmission assembly 46 further includes a shaft sleeve 462, the shaft sleeve 462 is received in the second massage portion 30. One axial end of the second shaft rod 461 is in torque transmission connection with the second segment 449, the other axial end of the second shaft rod 461 extends inclinedly relative to the axis of rotation and/or swing of the second massage portion 30 into the second massage portion 30 and is slidably engaged with the shaft sleeve 462. The actuator 43 drives the first segment 448, the second segment 449 and the first shaft rod 443 of the eccentric wheel 441 to rotate around the driving axis, the first shaft rod 443 drives the slider 442 to slide vertically in a reciprocating manner, and the slider 442 drives the first and second swing rods to swing laterally toward or away from each other, thereby achieving the swing of the first and second contact bodies 21, 22 toward or away from each other. Meanwhile, the driving axis is the pivot axis 34 of the second massage portion 30, the second segment 449 drives the second shaft rod 461 to rotate around the driving axis, the second shaft rod 461 extends inclinedly relative to the driving axis into an end of the second massage portion 30 and drives the second massage portion 30 to rotate and/or swing around the driving axis. In this way, the penis can be massaged in multiple directions and multiple angles through the pinching of the first and second contact bodies 21, 22 of the first massage portion 20 in combination with the swing and/or rocking of the second massage portion 30, which provides users with an enhanced stimulation and improved experience.

In some embodiments of the present disclosure, referring to FIG. 6, the eccentric wheel 441 is a one-piece structure so that the overall structural strength is better. In other embodiments of the present disclosure, the first segment 448 and the first shaft rod 443 are a one-piece structure. Alternatively, the first shaft rod 443 and the second segment 449 are a one-piece structure. Alternatively, the first segment 448, the first shaft rod 443, and the second segment 449 are all separately formed, and are then assembled together to form the eccentric wheel 441, thereby further reducing the difficulty of machining the eccentric wheel 441 and lowering the manufacturing cost.

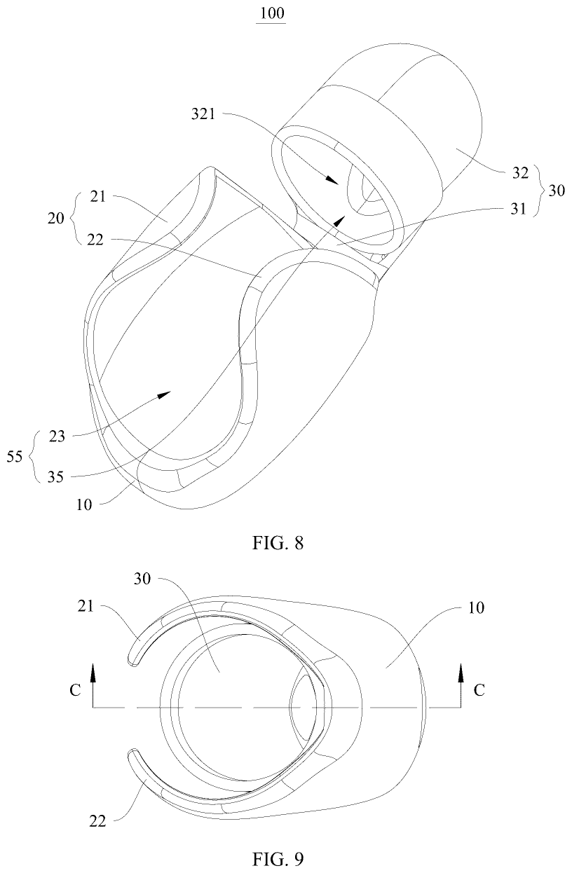

In one embodiment of the present disclosure, referring to FIGS. 8 to 11, one axial end of the second shaft rod 461 is directly in torque transmission connection with the actuator 43, the other axial end of the second shaft rod 461 extends inclinedly relative to pivot axis 34 into the second massage portion 30 and is slidably engaged with the shaft sleeve 462, and drives the second massage portion 30 to rotate and/or swing around the driving axis. That is, without the need of pinching movement achieved by the first massage portion 20, the second shaft rod 461 can be directly in torque transmission connection with the output shaft 431 of the actuator 43, thereby driving the second massage portion 30 to rotate and/or swing around the driving axis for massage.

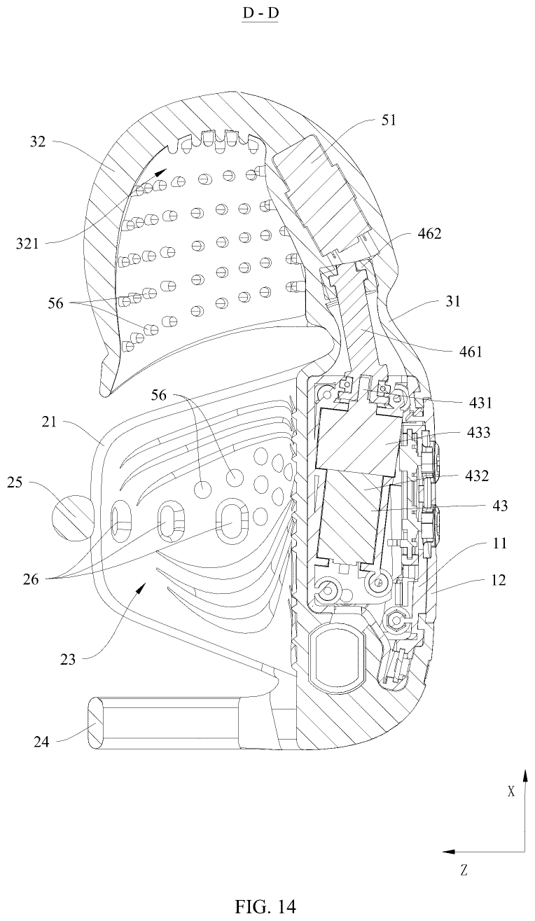

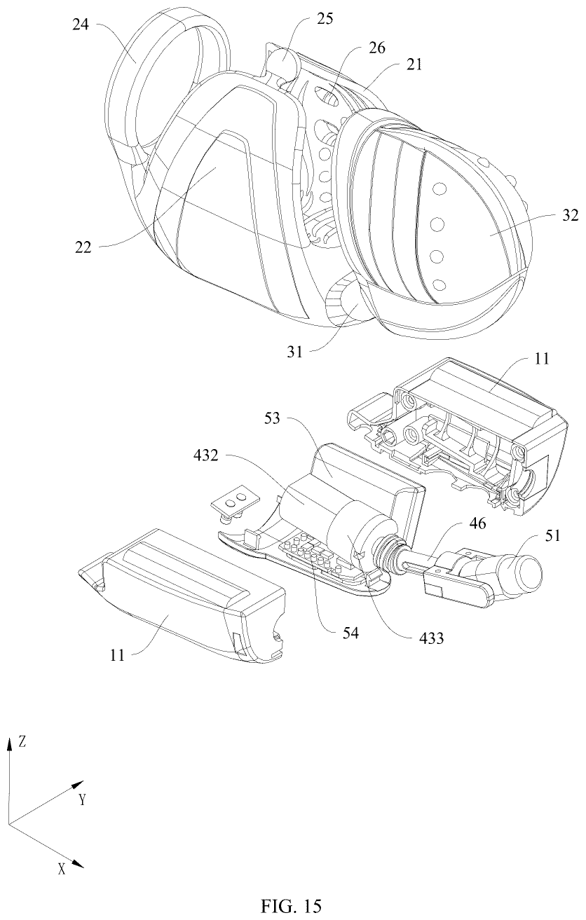

In one embodiment of the present disclosure, referring to FIGS. 3, 6, 10, 11, 14, and 15, preferably, the actuator 43 further includes a gearbox 432 in torque transmission connection with the motor shaft of the driving motor 431. The gearbox 432 has an output shaft serving as the output shaft 431 of the actuator 43, which is connected to one of the first transmission assembly 44 and the second transmission assembly 46. In some embodiments, a transmission ratio of the gearbox 432 is in a range of 5:1 to 100:1, which can improve the torque output of the driving motor 431.

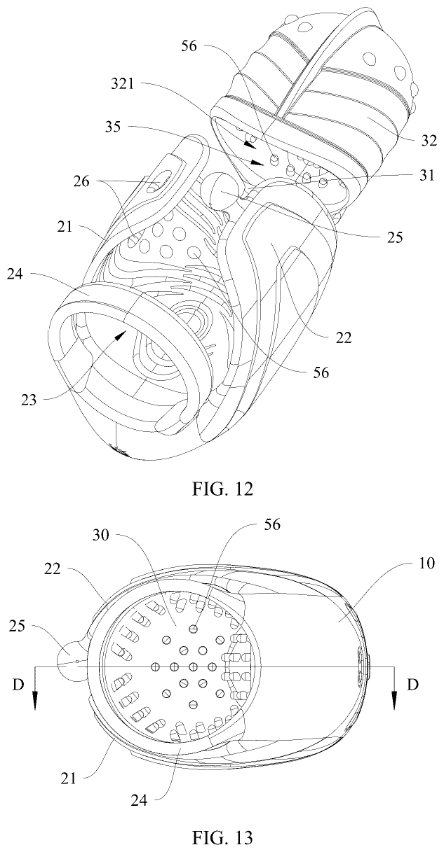

In one embodiment of the present disclosure, referring to FIGS. 12 to 15, both the first contact body 21 and the second contact body 22 are provided with a plurality of granular bumps 56 on a wall towards the receiving cavity 23. In particular, an inner wall of the massage cavity 321 of the second massage portion 30 also has a plurality of granular bumps 56, and the plurality of granular bumps 56 is able to increase friction between the inner wall of the massage cavity 321 and the penis, and thus increase the stimulation effect on the penis.

In some embodiments, the distal ends of first contact body 21 and the second contact body 22 are spaced apart, as the first contact body 21 and the second contact body 22 are flexible, the radial size of the receiving cavity 23 can be adjusted to be larger but the minimal radial size of the receiving cavity 23 is substantially fixed. However, in some cases, there may be individuals having penis sizes much smaller than the minimal radial size of the receiving cavity 23, and thus may be unsatisfied during use. To solve this problem, in some embodiments, distal ends of the first contact body 21 and the second contact body 22 can be detachably connected to decrease the radial size of the receiving cavity 23.

In one embodiment, the first contact body 21 and the second contact body 22 are connectable through a protrusion 25 and one or more holes 26. For example, as shown in FIG. 12, one of the first contact body 21 and the second contact body 22 is provided with one or more holes 26, and the other of the first contact body 21 and the second contact body 22 is provided with a protrusion 25 engageable to the hole 26, and the protrusion 25 is detachably engaged in each of the at least one hole 26 to achieve connection between distal ends of the first contact body 21 and the second contact body 22.

The protrusion 25 may have a shape of, but is not limited to, a ball-shaped, button-shaped, or other shape. In use, the protrusion 25 may be engaged into the hole 26 as required to adjust the radial size of the receiving cavity 23, thereby further adapting to the penis sizes of different users.

Specifically, in one embodiment, the first contact body 21 is provided with three holes 26 that are spaced apart from each other along a circumferential direction of the receiving cavity 23, and the second contact body 22 is provided with a ball-shaped protrusion 25 at the distal end. In use, if the user finds that the receiving cavity 23 has a size greater than the size of the penis which may result in unsatisfied massage effect, the user can choose an appropriate one from the holes 26 and make the ball-shaped protrusion 25 be engaged with the hole 26, as such, the receiving cavity 23 can be adjusted to a size that is more suitable to the penis, in which case the first and second contact bodies 21, 22 can cooperatively wrap the penis and conform an outer periphery of the penis, which will improve the massage experience significantly during use.

In one embodiments of the present disclosure, referring to FIG. 12, the sex toy 100 further includes a ring 24. The ring 24 is located adjacent to an axial end of the first massage portion 20 away from the second massage portion 30. Preferably, the ring 24 is spaced apart from the first and second contact bodies 21, 22. Preferably, an opening of the ring is at least partially aligned with the receiving cavity 23 of the first massage portion 20 in the axial direction. The ring 24 is configured to be mounted around a body part of the male, for example, the penis or the scrotum, which may inhibit the ejaculation and prolong the sexual duration.

In one embodiment of the present disclosure, referring to FIGS. 4 to 6, the sex toy 100 further includes a battery 53 for power supply, and the battery 53 is electrically connected to the driving motor 43 and the at least one vibration motor 51. The battery 53 may be detachable and replaceable for easy replacement, the battery 53 may also be a rechargeable battery permanently fixed within the shell 10.

In one embodiment of the present disclosure, referring to FIGS. 4 to 6, the sex toy 100 further includes a circuit board 54 electrically connected to the battery 53 and the driving motor 43. A control button is disposed on the shell 10, so that users can manipulate the circuit board 54 through the control button to operate the driving motor 43, such as starting, stopping, and adjusting the speed, as well as controlling the start/stop, vibrating frequency, and other functions of the vibration motor 51.

The embodiment of the present disclosure achieves multiple massage effects on the penis through swing and vibration of the first massage portion 20, as well as rocking, swing, and/or vibration of the second massage portion 30. It should be understood that the first and second massage portions 20, 30 may perform other forms of movement, as long as they can generate massage effects on users, and the present disclosure does not particularly limit this. In addition, the two massage portions 20, 30 may have different forms of movement, or may have the same form of movement. Users may activate both massage portions 20, 30 simultaneously or only one of the massage portions 20, 30 as desired.

Finally, it should be noted that: the above merely describes preferred embodiments of the present disclosure without intention to limit the scope of the present disclosure. Although the present disclosure has been described in detail with reference to the foregoing embodiments, for those skilled in the art, the technical solutions described in the foregoing embodiments can still be modified, or some of the technical features can be equally replaced. Any modifications, equivalent replacements, improvements, and etc. made within the spirit and principle of the present disclosure should be within the scope of the present disclosure.

What is claimed is:

1. A sex toy, comprising:
a shell;
a first massage portion, connected to the shell and defining a receiving cavity for receiving a male penis;
a second massage portion, connected to the shell and located at an axial end of the receiving cavity;
a driving unit, received in the shell and in transmission connection with the second massage portion to drive the second massage portion to rotate and/or swing relative to the first massage portion,
wherein an axis of rotation and/or swing of the second massage portion is misaligned with a central axis of the receiving cavity of the first massage portion.

2. The sex toy according to claim 1, wherein the axis of rotation and/or swing of the second massage portion is parallel to the central axis of the receiving cavity of the first massage portion.

3. The sex toy according to claim 1, wherein the axis of rotation and/or swing of the second massage portion is perpendicular to the central axis of the receiving cavity of the first massage portion.

4. The sex toy according to claim 1, wherein the first massage portion comprises a first contact body and a second contact body disposed on opposite sides of the shell, and the first and second contact bodies are curved structures.

5. The sex toy according to claim 4, wherein distal ends of the first and second contact bodies are spaced apart in a circumferential direction of the receiving cavity; or
distal ends of the first contact body and the second contact body are connected by an elastic body.

6. The sex toy according to claim 4, wherein distal ends of the first and second contact bodies are spaced apart in a circumferential direction of the receiving cavity, and the distal ends of the first contact body and the second contact body are detachably connectable to reduce a radial size of the receiving cavity.

7. The sex toy according to claim 6, wherein one of the first contact body and the second contact body is provided with one or more holes, and an other of the first contact body and the second contact body is provided with a protrusion, and the protrusion is detachably engageable with the hole or each of the holes.

8. The sex toy according to claim 1, further comprising a ring located adjacent to an axial end of the first massage portion away from the second massage portion.

9. The sex toy according to claim 1, wherein at least one of the first massage portion, the second massage portion, and the shell is provided with a vibration motor.

10. The sex toy according to claim 1, wherein the second massage portion is cylindrical, and an inner space of the second massage portion is communicated with the receiving cavity of the first massage portion to form a massage space together.

11. The sex toy according to claim 10, wherein one end of the second massage portion facing towards the first massage portion is open, and an other end of the second massage portion opposite to the one end is closed; or
both ends of the second massage portion are open.

12. The sex toy according to claim 1, wherein an inner space of the second massage portion is substantially coaxial with the receiving cavity of the first massage portion.

13. The sex toy according to claim 1, wherein the second massage portion is a plate-like structure or block-like structure, the second massage portion extends inclinedly from an end of the shell relative to its own axis of rotation and/or swing.

14. The sex toy according to claim 4, wherein the driving unit is in transmission connection with the first massage portion to drive the first and second contact bodies to move towards or away from each other.

15. The sex toy according to claim 14, wherein the driving unit comprises a first swing rod and a second swing rod disposed opposite to each other, the first and second swing rods are rotatably disposed in the shell to drive the first and second contact bodies to swing towards or away from each other.

16. The sex toy according to claim 15, wherein the driving unit comprises a actuator, a first transmission assembly and a second transmission assembly, the first transmission assembly is connected between the actuator and the first massage portion, the second transmission assembly is connected between the actuator and the second massage portion.

17. The sex toy according to claim 16, wherein the first transmission assembly comprises an eccentric wheel and a slider, the eccentric wheel rotates about a driving axis under the drive of the actuator, the eccentric wheel has a first shaft rod extending outwardly, the first shaft rod is eccentrically arranged relative to the driving axis, the slider has a sliding groove, and the first shaft rod is movably engaged with the sliding groove, one end of the first swing rod and one end of the second swing rod are movably engaged with the slider, an other end of the first swing rod and an other end of the second swing rod extend into the first and second contact bodies, respectively; and wherein the second transmission assembly comprises a second shaft rod, one end of the second shaft rod is connected to the eccentric wheel, an other end of the second shaft rod extends into the second massage portion inclinedly relative to the axis of rotation and/or swing of the second massage portion.

18. A sex toy, comprising:
a shell;
a first massage portion, connected to the shell, the shell and the first massage portion cooperatively defining a receiving cavity for accommodating a penis, the first massage portion providing a first stimulation to the penis;
a second massage portion, connected to the shell and located at an axial end of the receiving cavity;
a driving unit, in transmission connection with the second massage portion to drive the second massage portion to rotate and/or swing relative to the first massage portion and providing a second stimulation to the penis different from the first stimulation.

19. The sex toy according to claim 18, wherein a central axis of the receiving cavity and an axis of rotation and/or swing of the second massage portion both extend in axial directions and are spaced apart in a vertical direction.

20. The sex toy according to claim 18, wherein the second massage portion is substantially cylindrical and hollow with opposite first and second axial ends, the first axial end facing the first massage portion is open, and the second axial end facing away from the first massage portion is open or closed.

21. The sex toy according to claim 18, wherein the second massage portion comprises a connection body and an ellipsoid body, and two axial ends of the connection body are connected to the shell and the ellipsoid body, respectively.

22. The sex toy according to claim 18, wherein the first massage portion comprises a first contact body and a second contact body disposed on opposite sides of the shell, distal ends of the first and second contact bodies are spaced apart in a circumferential direction of the receiving cavity, and the distal ends of the first contact body and the second contact body are detachably connectable to reduce a radial size of the receiving cavity.

23. The sex toy according to claim 18, further comprising a ring located adjacent to an axial end of the first massage portion away from the second massage portion.
